(19) United States
(12) Patent Application Publication
(10) Pub. No.: US 2017/0291446 A1
(43) Pub. Date: Oct. 12, 2017

(54) RING BINDER HAVING INTERLOCKING RING TIPS

(71) Applicant: World Wide Stationery Mfg. Co. Ltd., Kwai Chung (CN)

(72) Inventor: Chun Yuen To, Shatin (CN)

(73) Assignee: World Wide Stationery Mfg. Co., Ltd., Kwai Chung (CN)

(21) Appl. No.: 15/134,008

(22) Filed: Apr. 20, 2016

(30) Foreign Application Priority Data
Apr. 6, 2016 (CN) 201610209761.7

(51) Int. Cl. B42F 13/26

(52) U.S. Cl. CPC B42F 13/26

(57) ABSTRACT

A ring binder has an elongate body and rings including ring members moveable between closed position and open positions. A retaining system selectively and releasably holds the ring members of at least one ring in the closed position. The retaining system includes interlocking formations adjacent ends of the ring members that are moveable between retaining and non-retaining positions. The first interlocking formation includes a recessed region and a projection extending upwardly. The second interlocking formation includes a vaulted region and a projection extending downwardly. The first projection is received in the vaulted region and the second projection is received in the recessed region when the interlocking formations are in the retaining position. The interlocking formations are configured so that movement of the interlocking formations relative to one another in the direction of a longitudinal axis of the body is blocked when the interlocking formations are in the retaining position.

### REFERENCE TO RELATED APPLICATIONS

This application claims priority from Chinese Patent Application No. 201610209761.7, filed Apr. 6, 2016, the entire contents of which are incorporated herein by reference.

### FIELD OF THE INVENTION

The present invention relates generally to a ring binder for retaining loose-leaf pages, and more particularly to a ring binder having ring members that have interlocking formations thereon to help hold the ring members in a closed position.

### BACKGROUND OF THE INVENTION

Ring binder mechanisms having rings for selectively retaining loose-leaf pages are well known. These mechanisms are commonly fastened to other structures such as notebook covers, files, clipboards, and the like to enable the rings to retain loose-leaf pages. The rings of ring binders typically include two ring members that are selectively movable between an open position for receiving loose-leaf pages and a closed position for retaining loose-leaf pages. Conventionally, the ring members are hingedly connected to a base for pivoting movement relative the base. When the ring binder retains loose-leaf pages in the closed position, it is preferable for the rings to remain secured in the closed position. For certain types of ring binder mechanism, when the rings are in the closed position, the rings are biased by a spring force towards the closed position to prevent unintended opening of the rings. The ring members of these and other types of ring binders can also include interlocking formations that secure the ring in the closed position. However, known interlocking formations can be prone to disengagement in response to the pivoting movement of the ring members relative to the base. For example, if a ring binder loaded with paper is dropped, the ring members can be subject to forces directed in ways that tend to open the rings. Some interlocking formations may be inadequate to resist such forces.

### SUMMARY

One aspect of the invention is a ring binder for use in holding loose-leaf pages. The ring binder has an elongate body extending along a longitudinal axis and rings for retaining loose-leaf pages. Each ring includes first and second ring members extending from the elongate body. The first and second ring members are moveable relative to one another between a closed position and an open position. In the closed position the first and second ring members together form a substantially continuous, closed loop for allowing loose-leaf pages retained by the ring to be moved along the ring from one ring member to the other. In the open position the first and second ring members form a discontinuous, open loop for adding or removing loose-leaf pages from the ring. The ring binder also includes a retaining system operable to selectively and releasably hold the first and second ring members of at least one of the rings in the closed position. The retaining system includes first and second interlocking formations adjacent ends of the first and second ring members, respectively, of the ring. The first and second interlocking formations are selectively moveable relative to one another between a retaining position in which the retaining system holds the first and second ring members in the closed position and a non-retaining position in which the retaining system does not hold the first and second ring members in the closed position. The interlocking formation of the first ring member includes a recessed region and a first projection. The first projection extends generally upwardly relative to the recessed region at a position located distally on the first ring member relative to the first recessed region. The interlocking formation of the second ring member includes a vaulted region and a second projection. The second projection extends generally downwardly relative to the vaulted region at a position located distally on the second ring member relative to the vaulted region. The first projection is received in the vaulted region and the second projection is received in the recessed region when the interlocking formations are in the retaining position. The interlocking formations are configured so that movement of the interlocking formations relative to one another in the direction of the longitudinal axis of the body is blocked when the interlocking formations are in the retaining position.

Other objects and features will be in part apparent and in part pointed out hereinafter.

### BRIEF DESCRIPTION OF THE DRAWINGS

FIG. 1 is a perspective of one embodiment of a ring mechanism mounted on a notebook showing the rings in a closed position;

FIG. 2 is a perspective of the ring mechanism showing the rings in an open position;

FIG. 3 is an enlarged perspective of a portion of the ring mechanism of FIG. 1 showing an interlocking formation at the end of one of the ring members;

FIG. 4 is an enlarged side elevation of a portion of the ring mechanism showing the interlocking formation illustrated in FIG. 3;

FIG. 5 is an enlarged front elevation of a portion of the ring mechanism showing the interlocking formation illustrated in FIG. 3;

FIG. 6 is an enlarged top plan of a portion of the ring mechanism showing the interlocking formation illustrated in FIG. 3;

FIG. 7 is an enlarged perspective of a portion of the ring mechanism of FIG. 1 showing an interlocking formation at the end of another of the ring members that is configured to engage the interlocking formation illustrated in FIGS. 3-6 when the rings are closed;

FIG. 8 is an enlarged side elevation of a portion of the ring mechanism showing the interlocking formation illustrated in FIG. 7;

FIG. 9 is an enlarged rear elevation of a portion of the ring mechanism showing the interlocking formation illustrated in FIG. 7;

FIG. 10 is an enlarged bottom plan of a portion of the ring mechanism showing the interlocking formation illustrated in FIG. 7;

FIG. 11 is an enlarged perspective of a portion of the ring mechanism illustrated in FIG. 1 showing the interlocking formations of FIGS. 3 and 7 engaged with one another;

FIG. 12 is another enlarged perspective similar to FIG. 11, but from a different vantage point;

FIG. 13 is an enlarged side elevation of a portion of the ring mechanism illustrated in FIG. 1 showing the interlocking formations of FIGS. 3 and 7 engaged with one another;

FIG. 14 is an enlarged cross section of a portion of the ring mechanism taken in a plane including line 14-14 on FIG. 1 showing the interlocking formations of FIGS. 3 and 7 engaged with one another;

FIG. 15 is an enlarged cross section of a portion of the ring mechanism taken in a plane including line 16-16 on FIG. 11 showing the interlocking formations of FIGS. 3 and 7 engaged with one another; and

FIG. 16 is an enlarged perspective of a portion of the ring mechanism illustrated in FIG. 1 showing the interlocking formations of FIGS. 3 and 7 engaging/disengaging one another.

Corresponding reference characters indicate corresponding parts throughout the drawings.

### DETAILED DESCRIPTION

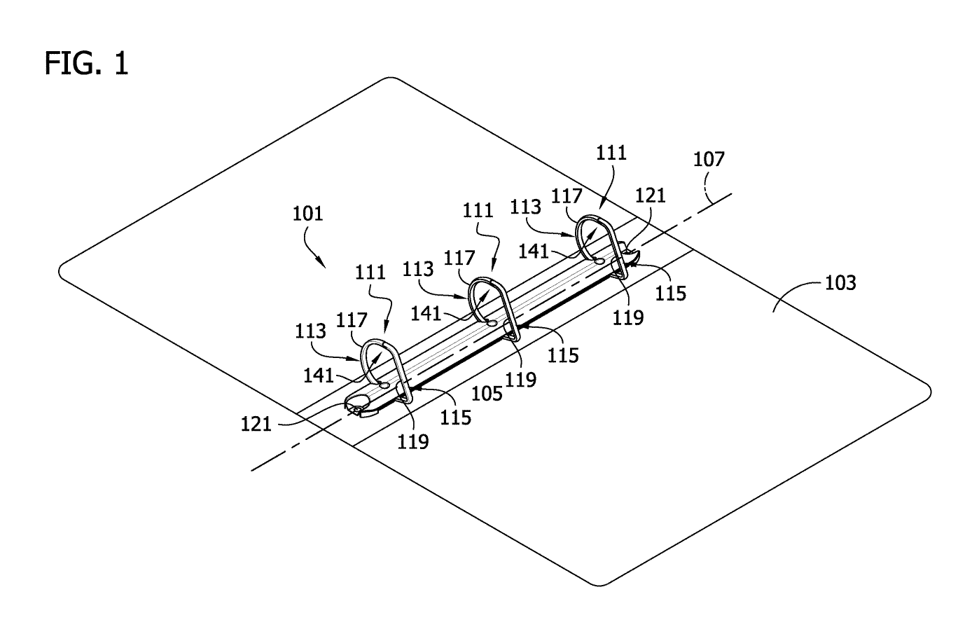

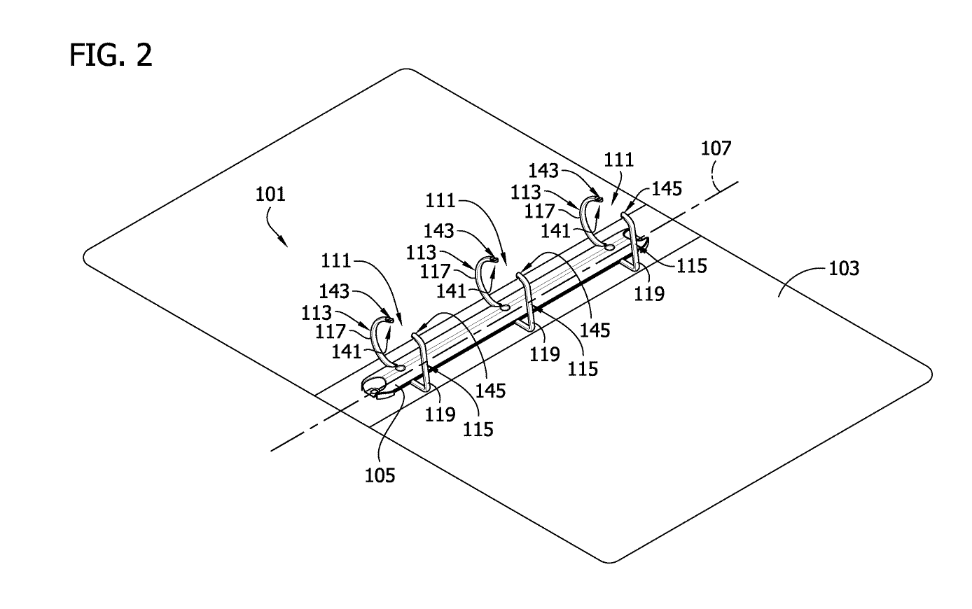

Referring now to the drawings, first to FIGS. 1-2, one embodiment of a ring binder, generally designated 101, is secured to a notebook 103. The ring binder 101 could also be secured to a different structure instead of a notebook, such as a clipboard, briefcase, etc. It is also understood the ring binder 101 does not have to be attached to a notebook or any other structure within the broad scope of the invention.

The ring binder has a plurality of rings, each of which is generally designated 111. In the illustrated embodiment, the ring binder 101 has three rings 111, but there could be two rings or more than three rings instead. The rings 111 are supported by and extend above a housing 105 (generally, a body). The housing 105 is generally elongate and has a longitudinal axis 107. The housing 105 is suitably adapted for being fastened to the notebook 103 or other structure. Referring to FIG. 1, for instance, the housing 105 has a pair of openings 121 at opposite ends for receiving fasteners (not shown) to secure the housing, and thereby the ring binder, to the notebook 103 or other structure. In the illustrated embodiment, the housing 105 is made of metal (e.g., nickel-plated steel), but the housing could be constructed of other materials (e.g., a polymeric material) instead.

Each ring 111 includes a pair of ring members 113, 115 extending from opposite sides of the housing 105. The ring members 113, 115 are moveable relative to one another between a closed position (FIG. 1) and an open position (FIG. 2). In the closed position, the ring members 113, 115 form a substantially continuous, closed loop for allowing loose-leaf pages retained by the ring 111 to be moved along the ring from one ring member to the other. In the open position, the ring members 113, 115 form a discontinuous, open loop for adding or removing loose-leaf pages from the ring 111. In the illustrated embodiment, each of the ring members 113, 115 pivots relative to the housing 105 between the open and closed positions. This can be achieved by mounting each of the ring members 113, 115 to one of a pair of hinge plates (not shown) that pivot inside the housing. However, other types of mechanisms can be used instead of hinge plates to produce the movement of the ring members 113, 115 between the open and closed positions. It is also understood that one of the ring members may be stationary, while the other ring member pivots, or otherwise moves, between the open and closed positions.

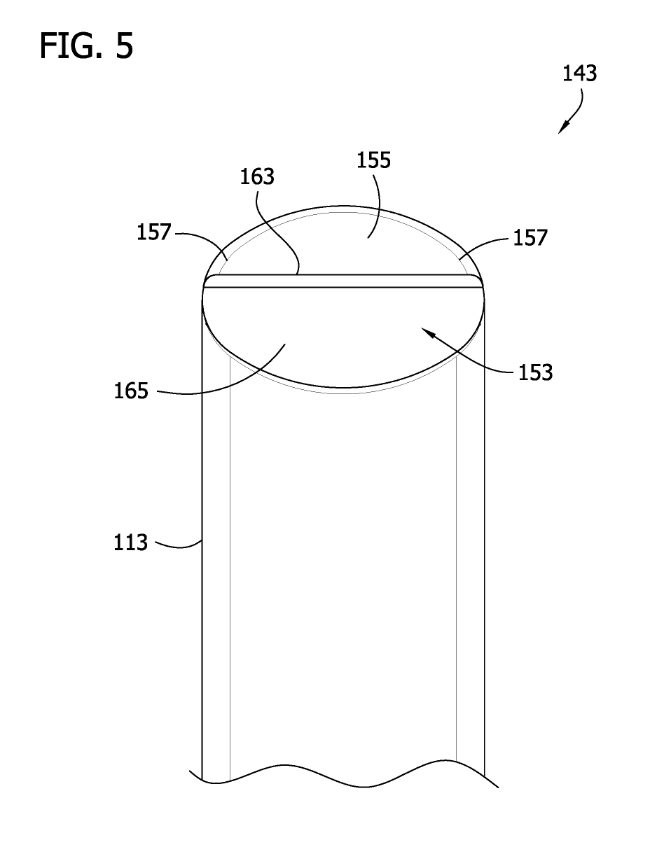

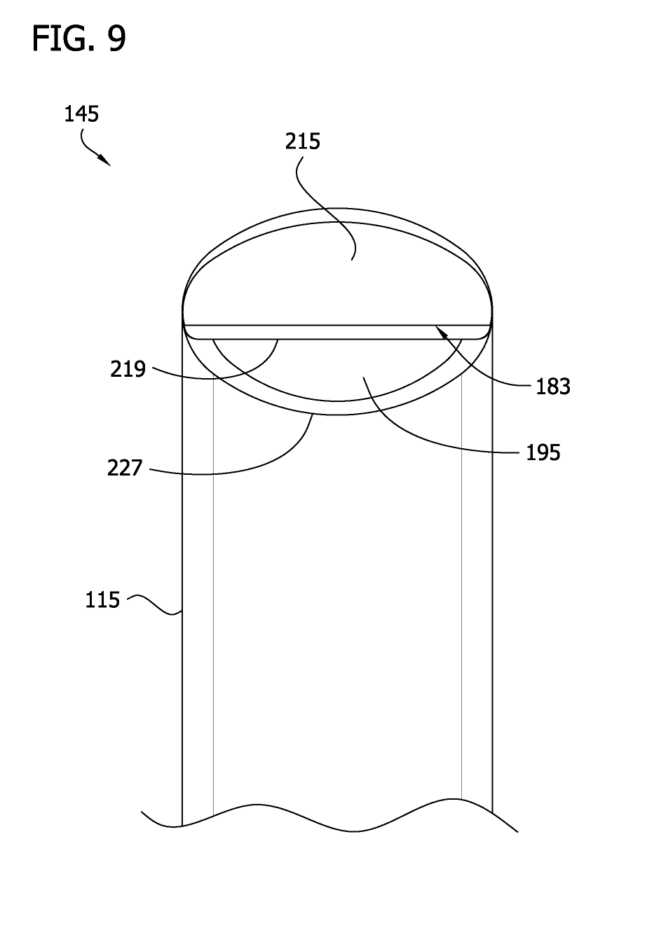

As illustrated in FIGS. 5 and 9, the ring members 113, 115 suitably have a generally elliptical cross sectional shape. In the illustrated embodiment, the cross sectional shape of the ring members 113, 115 is substantially constant along the entire length of the ring members that is external of the housing. However, it is understood the cross sectional shape of the ring members can vary along the length of the ring members. Likewise other cross sectional shapes (e.g., substantially circular) can be used instead. Referring to FIGS. 1 and 2, one of the ring members 113 has a generally circularly-shaped segment 117 extending generally from the tip of the ring member to about the housing 105 while the other ring member 115 has a straight slanted side 119. The rings 111 formed by these two differently-shaped ring members 113, 115 are known in the industry as D-rings. However, the rings can have different shapes if desired. The ring members 113, 115 in the illustrated embodiment are both made of metal. However, it is understood the rings 111 may be made of other materials if desired. For example, the rings can be made of a polymeric material if desired.

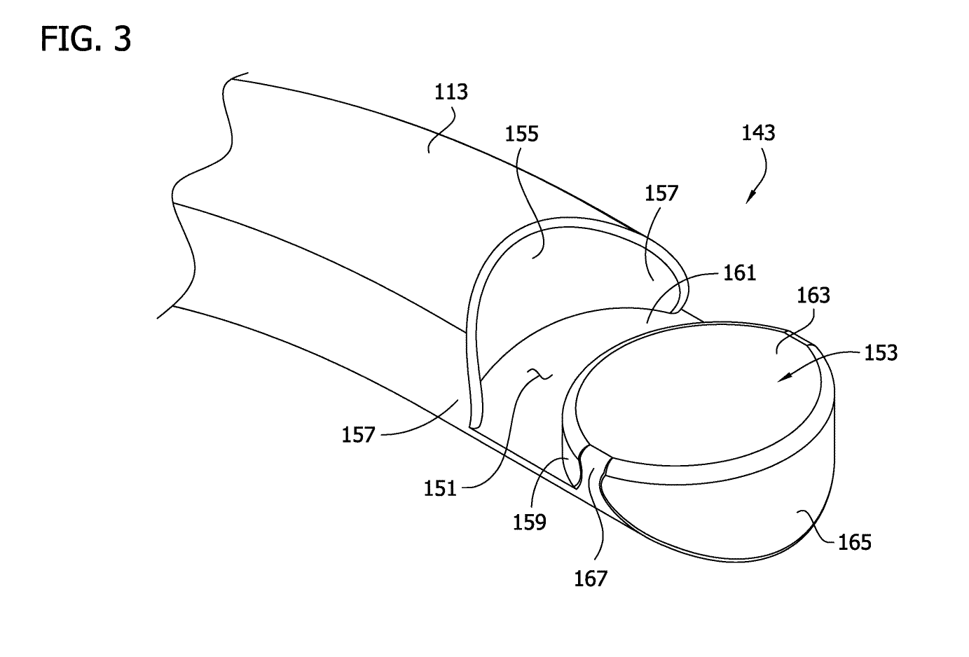

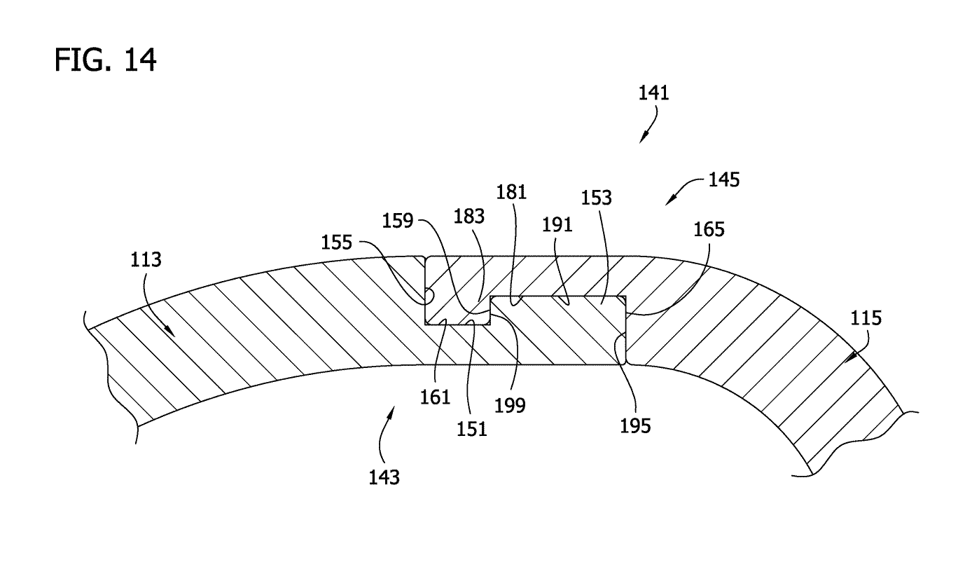

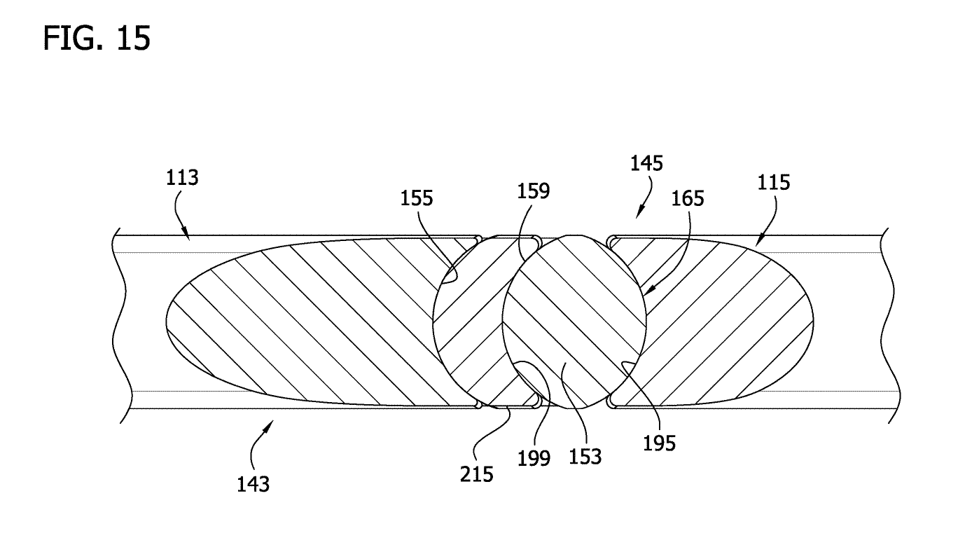

The ring binder 101 has a retaining system 141 operable to selectively and releasably hold the ring members 113, 115 in the closed position. As illustrated in FIGS. 3-16, the retaining system 141 has first and second interlocking formations 143, 145 adjacent ends of the ring members 113, 115, respectively. In the illustrated embodiment, each ring 111 has identical interlocking formations 143, 145 on the ends of its ring members 113, 115. Thus, a description of the interlocking formations 143, 145 on just one of the rings 111 will suffice to describe them all. However, it is understood that the interlocking formations on some of the rings may be different from the interlocking formations on others of the rings. Also, some of the rings may not have any interlocking formations. For example, a retaining system could include just one set of interlocking formations on a single one of the rings (e.g., the middle ring in a set of three rings) if desired.

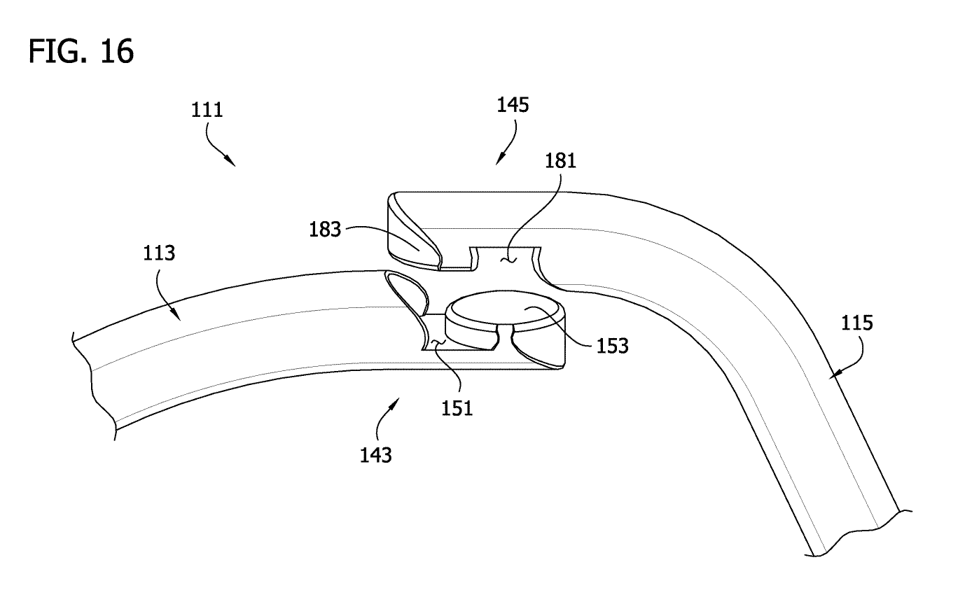

The interlocking formations 143, 145 are selectively moveable relative to one another between a retaining position (FIGS. 1 and 11-15) and a non-retaining position (FIG. 16). When the interlocking formations 143, 145 are in the retaining position the retaining system 141 holds the ring members 113, 115 in the closed position. When the interlocking formations 143, 145 are in the non-retaining position the retaining system 141 does not hold the ring members 113, 115 in the closed position.

Referring to FIGS. 3-6, the interlocking formation 143 of the first ring member 113 includes a recessed region 151 and an upwardly-extending projection 153. The projection 153 is at a position located distally on the ring member 113 relative to the recessed region 151. In the illustrated embodiment, for example, the projection 153 is at the very end of the ring member 113 while the recessed region 151 is separated from the very end of the ring member by the projection. In other words, the recessed region 151 is spaced inward from the very tip of the ring member 113 by the projection 153.

The recessed region 151 is defined by a bottom 161 and pair of sidewalls 155, 159 on opposite sides of the bottom. One of the sidewalls 155 is concave and the other sidewall 159 is convex. The concave sidewall 155 is suitably formed by the main body of the ring member 113 where the interlocking formation 143 is connected to the main body of the ring member. The convex sidewall 159 is suitably a sidewall of the projection 153. Collectively, the bottom 161 and sidewalls 155, 159 form an open-sided channel, constituting the recessed region 151, that extends generally transversely all the way through the ring member 113 between opposite sides of the interlocking formation 143.

At least one of the sidewalls 155, 159 is not straight. In the illustrated embodiment, for example, each of the sidewalls 155, 159 forming the sides of the recessed region is curved. More particularly, in the illustrated embodiment each of the sidewalls 155, 159 has an arcuate generally cylindrical shape. The ring member 113 can also be considered to have a pair of arms 157 extending toward the projection 153 on opposite sides of a centerline 175 of the ring member 113. The sidewall 155 formed by the arms 157 is arcuate because the surfaces of the arms facing the projection 153 are generally cylindrical. The open-sided channel formed by the bottom 161 and sidewalls 155, 159 of the recessed region 151 is also arcuate.

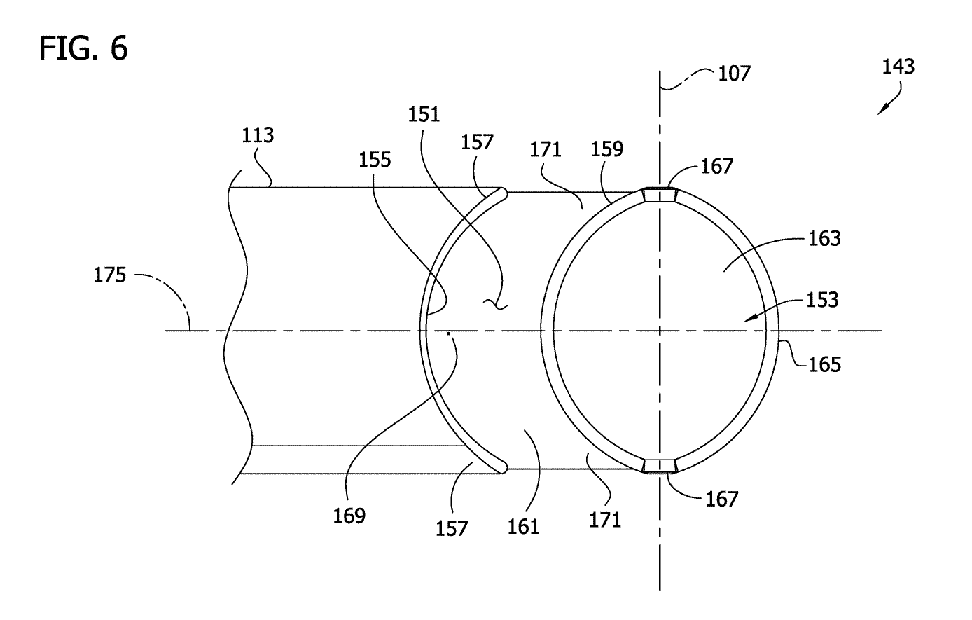

There is at least one area in the recessed region for which a path in the direction parallel to longitudinal axis 107 of the housing 105 is physically blocked by at least one of the sidewalls 155, 159. Referring to FIG. 6, for example, the path from the point labelled 169 extending parallel to the longitudinal axis 107 of the housing 105 is blocked in both directions by the sidewall 155 formed by the arms 157. The paths from the points labelled 171 in FIG. 6 extending parallel to the longitudinal axis 107 are blocked in one direction by the sidewall 159 of the projection 153.

There are various ways the interlocking formation can be configured to result in at least one area of the recessed region being positioned where a path extending parallel to the longitudinal axis 107 of the housing is physically blocked by the interlocking formation. In the illustrated embodiment, the bottom 161 is substantially flat and the sidewalls 155, 159 have a substantially continuous radius of curvature and the radius of curvature for each sidewall is substantially equal in length to the radius of curvature of the other sidewall. The distance between the sidewalls measured along a path parallel to the centerline 175 of the ring member 113 is also substantially constant. The open-sided channel formed by the bottom 161 and sidewalls 155, 159 that constitutes the recessed region 151 is substantially uniform in width as it extends transversely across the ring member 113. However, it is understood that other configurations are possible within the broad scope of the invention.

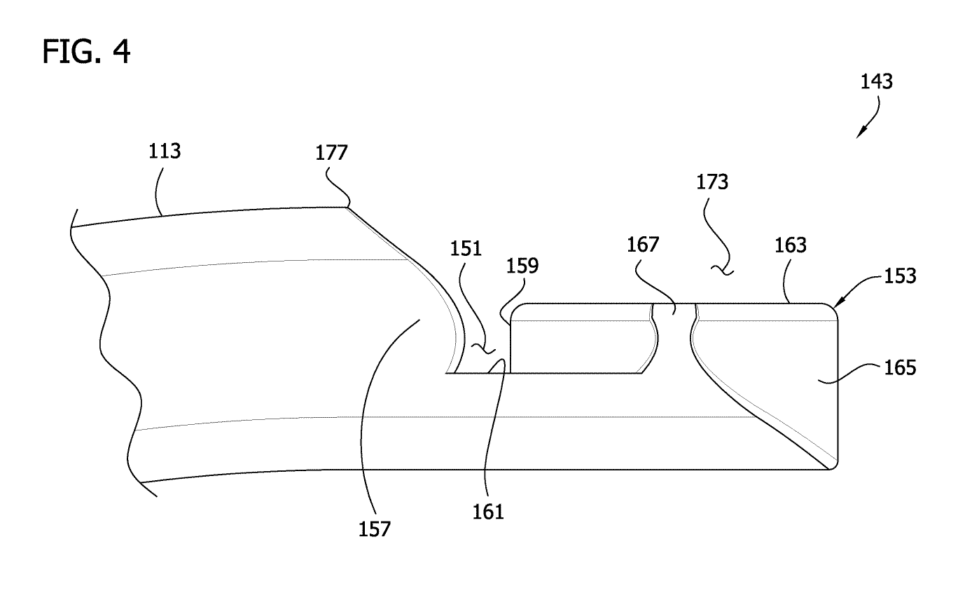

The projection can have various shapes without departing from the scope of the invention. As illustrated in FIG. 6, the projection 153 suitably has a cross sectional shape that has an axis of symmetry that is parallel to the centerline 175 of the rings 113 and another axis of symmetry that is parallel to the longitudinal axis 107 of the housing 105. The sidewall 165 of the projection 153 forming the very distal tip of the ring member 113 suitably has a cylindrical shape having a radius of curvature that is substantially equal in length to the radius of curvature of the sidewall 159 facing the recessed region 151. The projection 153 also has a pair of sidewall segments 167 on opposite sides of the projection between the sidewalls 159, 165 that have less curvature. For example, these segments 167 may have a radius of curvature that is larger in length than the radius of curvature for one or both of the sidewalls 159, 165. Referring to FIG. 4, there is a void space 173 above the projection 153 resulting from the top 163 of the projection being at an elevation that is lower than highest point 177 of the interlocking formation 143, which is the highest point on the sidewall 155 in the illustrated embodiment.

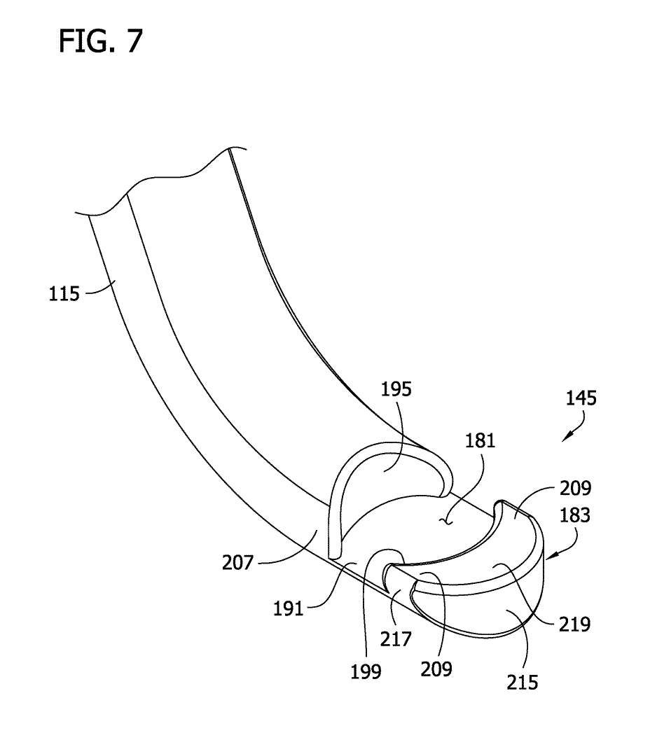

Referring to FIGS. 7-10, the interlocking formation 145 on the opposite ring member 115 includes a vaulted region 181 and a downwardly-extending projection 183. The projection 183 is at a position located distally on the ring member 115 relative to the vaulted region 181. In the illustrated embodiment, for example, the projection 183 is at the very end of the ring member 115 while the vaulted region 181 is separated from the very end of the ring member by the projection. In other words, the vaulted region 181 is spaced inward from the very tip of the ring member 115 by the projection 183.

The vaulted region 181 is defined by a top 191 and a pair of sidewalls 195, 199 on opposite sides of the top. Contrary to the other interlocking formation 143, the sidewalls 195, 199 in the interlocking formation 145 on this ring member 115 are both convex. Collectively, the top 191 and sidewalls 195, 199 form a void constituting the vaulted region 181 that extends generally transversely all the way through the ring member 115. At least one of the sidewalls 195, 199 is not straight. In the illustrated embodiment, for example, each of the sidewalls 195, 199 forming the sides of the vaulted region 181 is curved. More particularly, in the illustrated embodiment each of the sidewalls 195, 199 has an arcuate cylindrical shape. The ring member 115 can also be considered to have a pair of arms 207 extending toward the projection 183 on opposite sides of a centerline 205 of the ring member 115. The sidewall 195 formed by the arms 207 is arcuate because the surfaces of the arms facing the projection 183 are generally cylindrical. Similarly, the projection 183 can be considered to have a pair of arms 209 on opposite sides of the centerline 205 extending toward the sidewall 195. In the illustrated embodiment, the vaulted region 181 has a generally oblong oval-type shape. In particular, although the sidewalls 195, 199 have radii of curvature that are substantially equal in length, the spacing between the sidewalls is less than what it would be if the sidewalls were on opposite sides of a circle having that radius of curvature.

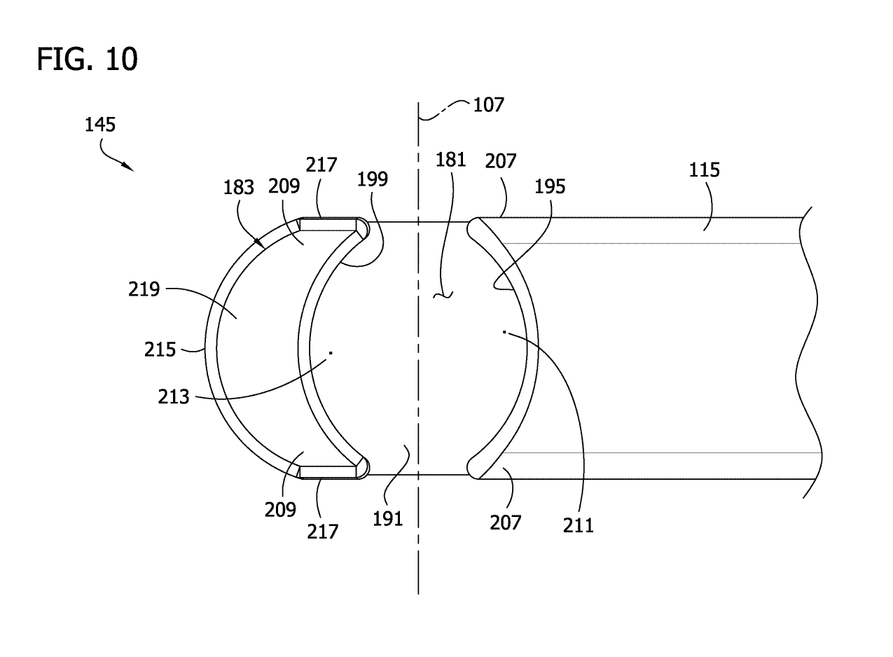

There is at least one area in the vaulted region for which a path in the direction parallel to longitudinal axis 107 of the housing 105 is physically blocked by at least one of the sidewalls 195, 199. Referring to FIG. 10, for example, the path from the point labelled 211 extending parallel to the longitudinal axis 107 of the housing 105 is blocked in both directions by the sidewall 195 formed by the arms 207. The path from the point labelled 213 in FIG. 10 extending parallel to the longitudinal axis 107 is blocked in both directions by the sidewall 199 of the projection 183.

There are various ways the interlocking formation can be configured to result in at least one area of the vaulted region being positioned where a path extending parallel to the longitudinal axis 107 of the housing is physically blocked by the interlocking formation. In the illustrated embodiment, the top 191 is substantially flat and the sidewalls 195, 199 have generally cylindrical shapes. However, it is understood that other configurations are possible within the broad scope of the invention.

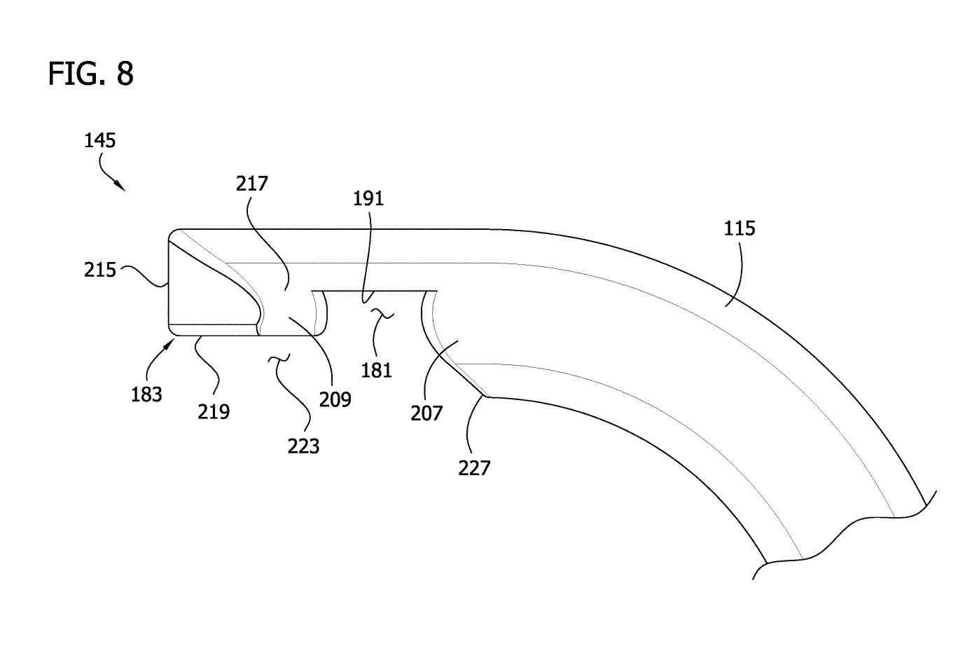

The projection on this interlocking formation 145 can have various shapes without departing from the scope of the invention. As illustrated in FIG. 6, the projection 183 suitably has a cross sectional shape that has an axis of symmetry that is parallel to the centerline of the rings 175. The side 215 of the projection 153 forming the very distal tip of the ring member 115 suitably has a convex cylindrical shape having a radius of curvature that is substantially equal in length to the radius of curvature of the sidewalls 195, 199 forming the vaulted region 181. The projection 153 also has a pair of sidewall segments 217 on opposite sides of the projection between the sidewalls 199, 215 that have less curvature. For example, these segments 217 may have a radius of curvature that is larger in length than the radius of curvature for one or both of the sidewalls 159, 165. In the illustrated embodiment, these segments 217 on the sides of the projection 183 are substantially planar. Referring to FIG. 8, there is a void space 223 above the projection 183 resulting from the bottom 211 of the projection being at an elevation that is higher than the lowest point 177 of the interlocking formation 145, which is the lowest point on the sidewall 195 in the illustrated embodiment.

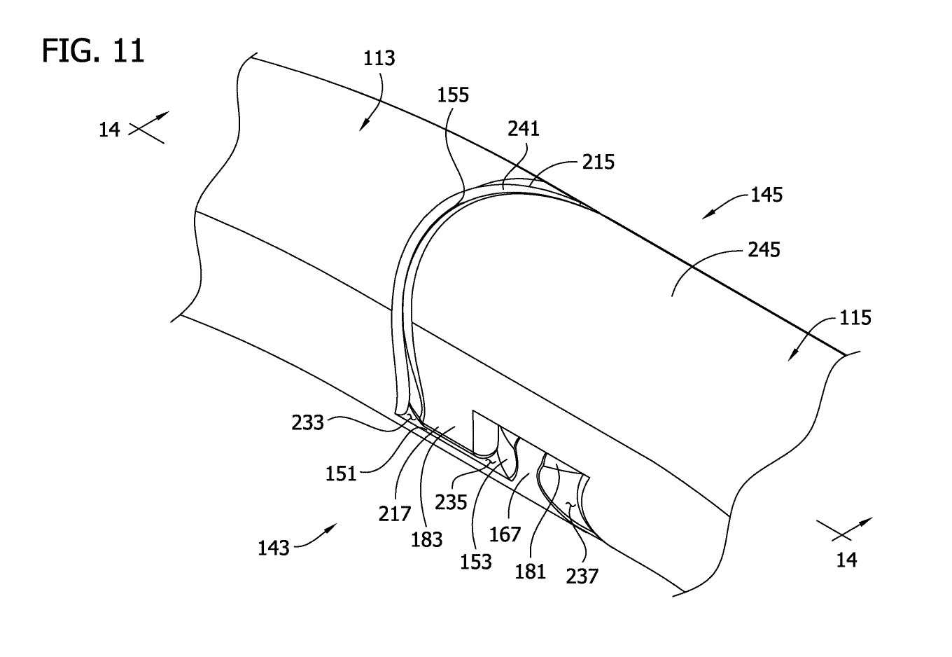

The vaulted region 181 has a shape that is suitable for receiving the projection 153 on the other interlocking formation 143, as illustrated in FIGS. 11-15. The projection 183 has a shape that is suitable for being received in the recessed region 151 on the other interlocking formation 143. Conversely, the projection 153 on the interlocking formation 143 is shaped to be received in the vaulted region 181 of the interlocking formation 145 and the recessed region 151 of the interlocking formation 143 is shaped to receive the projection 183 on the interlocking formation 145.

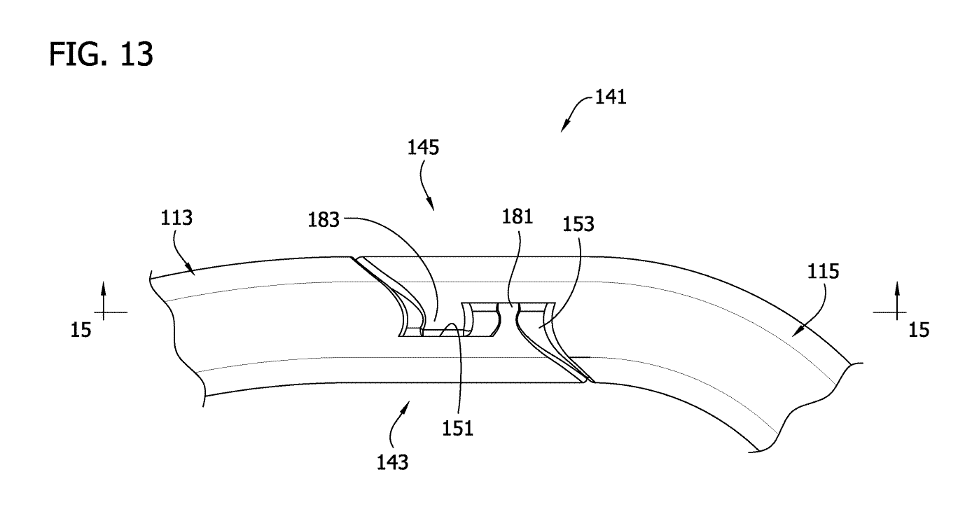

When the interlocking formations 143, 145 are in the retaining position (FIGS. 11-15), the projections 153, 183 extend into the vaulted region 181 and the recessed region 151, respectively. More particularly, in reference to FIG. 13, the bottom 219 of the downward extending projection 183 is at the bottom 161 of the recessed region 151. Likewise, the top 163 of the projection 153 is at the top 191 of the vaulted region 181.

Referring to FIG. 11, the curved outer end 215 of the interlocking formation 145 of ring member 115 is in generally conformal abutting position with the wall 155 of the interlocking formation 143 on ring member 113. There is only one joint 241 on the upper surface 245 of the ring 111 where the interlocking formations 143, 145 meet. This single joint 241 on the upper surface 245 of the rings is at the abutment of the sidewall 155 of ring member 113 with the curved distal end 215 of ring member 115. The vaulted region 181 does not extend all the way through the ring member 115. Thus, the vaulted region 181 is not associated with any edges or joints on the upper surface of the ring 111 that could catch or snag loose-leaf pages as they are moved along the ring over the retaining system 141.

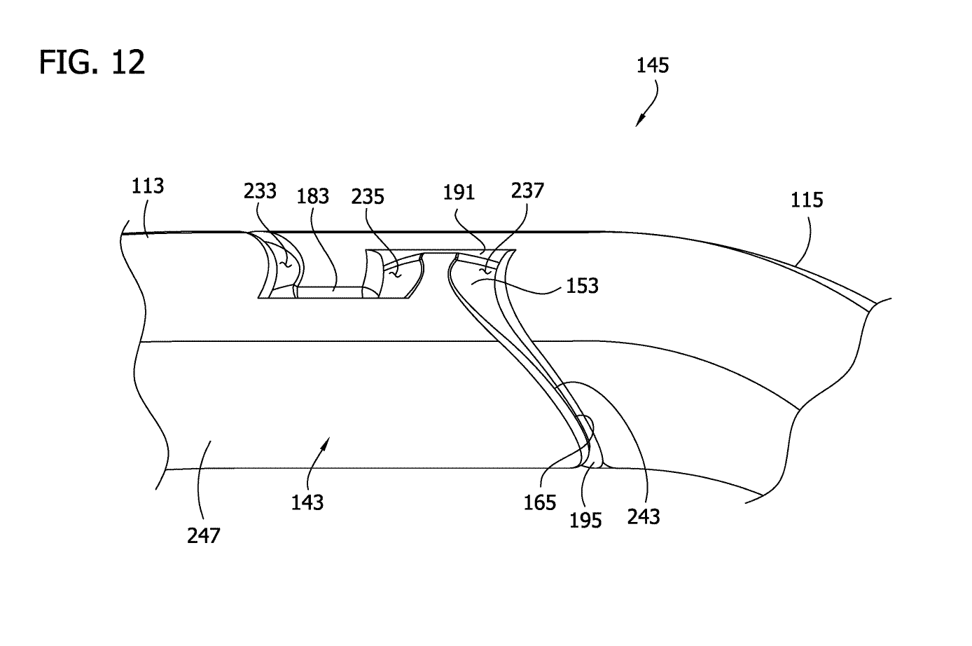

Referring to FIG. 12, the curved outer end of the interlocking formation 143 of ring member 113 is in generally conformal abutting relation with the wall 195 of the interlocking formation 145 on ring member 115. There is only one joint 243 on the lower surface 247 of the ring 111 where the interlocking formations 143, 145 meet. This single joint 243 on the lower surface 247 of the ring 111 is at the abutment of the sidewall 195 of ring member 115 with the curved distal end 165 of ring member 113. The vaulted recessed region 151 does not extend all the way through the ring member 113. Thus, the recessed region 181 is not associated with any edges or joints on the upper surface of the ring 111 that could catch or snag loose-leaf pages as they are moved along the ring over the retaining system 141.

There are several gaps 233, 235, 237 (FIGS. 11 and 12) on each side of the ring 111 (e.g., three gaps in the illustrated embodiment) that are associated with the interlocking formations 143, 145. The first gap 233 is associated with the abutment of the sidewall 155 of ring member 113 with the projection 183 of ring member 115. This gap 233 is the extension of the single joint between the sidewall 155 and the curved end 215 of ring member 115 on the upper surface of the ring 111 around to the sides of the ring. The second gap 235 is associated with the abutment of the projection 153, 183 with one another. This gap 235 is limited to the side of the ring 111 and does not extend over either of the upper or lower surfaces of the ring. The third gap 237 is associated with the abutment of the sidewall 195 of ring member 115 with the projection 153 of ring member 113. It is the extension of the single joint on the lower surface of the ring 111 where the curved end 165 of ring member 113 meets the sidewall 195 of ring member 115 around to the sides of the ring.

The potential for the gaps 233, 235, 237 to catch or snap loose-leaf pages is limited by several factors. For example, the structures forming each of the gaps 233, 235, 237 are rounded at the gaps to reduce or eliminate sharp edges that might more easily catch. Moreover, the rounded surfaces result in the actual joint where the ring members 113, 115 meet being spaced inward from the widest portions of the ring 111. Thus, any misalignments that might exist (e.g., due to tolerances) are positioned inside the outer footprint of the ring, where they are much less likely to contact the loose-leaf pages. Also, the gaps 233, 235, 237 are at the narrow ends of the elliptical cross sectional shape of the rings 111. The result is that a greater percentage of the peripheral outer surface of the rings 111 is free from these gaps 233, 235, 237 and has only a single joint (i.e., abutment of surfaces 195 and 165 or abutment of surfaces 155 and 215) that might catch loose-leaf pages.

When the interlocking formations 143, 145 are engaged, the retaining system 141 blocks opening movement of the ring members 113, 115 thereby holding the rings 111 in their closed position. In general, at least one of the interlocking formations 143, 145 has a projection that extends into a space in the other interlocking formation where movement from that space along the long axis 107 of the housing is blocked. For example, the abutting relation of the projections 153, 183 blocks movement of ends of the ring members 113, 115 away from one another in the opening direction. The interlocking formations 143, 145 are also configured so movement of the interlocking formations 143, 145 relative to another in directions parallel to the longitudinal axis 107 of the housing is also blocked. For example, the projection 153 on ring member 113 extends into one or more of the spaces 211, 213 in the interlocking formation 145 of ring member 115 where lateral movement in the direction parallel to the axis 107 of the housing 105 is blocked. Also, the projection 183 extends into one or more of the spaces 169, 171 in the interlocking formation 143 of ring member 113 where lateral movement in at least one direction is blocked.

Referring to FIG. 16, when a user wants to open the rings 111, he or she moves the ends of the ring members vertically relative to one another. The interlocking formations 143, 145 are configured so disengagement requires such vertical movement of the ends of the ring members 113, 115 relative to one another. More particularly, in the illustrated embodiment, the interlocking formations 143, 145 are configured so the end of ring member 113, and the interlocking formation 143 thereon, must be moved downward vertically relative to the end of ring member 115, and the interlocking formation 145 thereon, to disengage the retaining system 141. Conversely, the interlocking formations 143, 145 are configured so the end of ring member 115, and the interlocking formation 145 thereon, must be moved upward vertically relative to the end of ring member 113, and the interlocking formation 143 thereon, to disengage the retaining system 141. The ring members 113, 115 of the rings 111 are resiliently flexible enough to yield in the manner required to disengage the interlocking formations 143, 145 when a user manually moves them in this way, yet spring back into the retaining position when the user releases the ring members 113, 115.

Accordingly, to open the rings 111, a user pulls up on the end of ring member 115 and/or pushes down on the end of ring member 113 until they are positioned generally as illustrated in FIG. 16. Once the projections 153, 183 of the interlocking formations 143, 145 are withdrawn from the vaulted region 181 and recessed area 151, respectively, the user can open the rings by pulling the ring members 113, 115 apart from one another. Because this sequence of movements is the only way to disengage the retaining system 141 and result in opening of the rings 111, the ring binder 101 is resistant to accidental opening of the rings (e.g., if the ring mechanism is dropped). In order to close the rings, the order of the steps is reversed. The user first pushes the open ring members 113, 115 toward one another. Then, as the ring members 113, 115 approach their closed position, the user pulls up on the end of ring member 115 and/or pushes down on the end of ring member 113 to resiliently bend the ring members enough so the projections 153, 183 can clear one another. When the projections 153, 183 are generally in vertical alignment with the vaulted region 181 and recessed area 151, respectively, the user lets go, thereby allowing the natural resilient spring action of the ring members to move the projection 153 of ring member 113 into the vaulted region 181 of ring member 115 and move the projection 183 of ring member 115 into the recessed region 151 of ring member 113. At this point the retaining system 141 is engaged and interlocking formations 143, 145 are back in their retaining position.

As used herein, all terms indicating a particular orientation (e.g., up, down, vertical, lateral, side, etc.) are defined in reference to the orientation of the features as illustrated in FIG. 1. It is understood that the ring binder 101 can be re-oriented in any manner without departing from the scope of the invention. For example, if the ring mechanism 101 were re-oriented to be upside down relative to what is illustrated in FIG. 1, what is described herein as upward would instead be downward, and so on.

When introducing elements of the present invention or the preferred embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above apparatuses, systems, and methods without departing from the scope of the invention, it is intended that all matter contained in the above description and shown in the accompanying drawings shall be interpreted as illustrative and not in a limiting sense.

What is claimed is:

1. A ring binder for use in holding loose-leaf pages, the ring binder comprising:
an elongate body extending along a longitudinal axis;
rings for retaining loose-leaf pages, each ring including first and second ring members extending from the elongate body, the first and second ring members being moveable relative to one another between a closed position in which the first and second ring members together form a substantially continuous, closed loop for allowing loose-leaf pages retained by the ring to be moved along the ring from one ring member to the other and an open position in which the first and second ring members form a discontinuous, open loop for adding or removing loose-leaf pages from the ring; and
a retaining system operable to selectively and releasably hold the first and second ring members of at least one of the rings in the closed position, the retaining system comprising first and second interlocking formations adjacent ends of the first and second ring members, respectively, of said at least one ring, the first and second interlocking formations being selectively moveable relative to one another between a retaining position in which the retaining system holds the first and second ring members in the closed position and a non-retaining position in which the retaining system does not hold the first and second ring members in the closed position,
wherein the interlocking formation of the first ring member includes a recessed region and a first projection, the first projection extending generally upwardly relative to the recessed region at a position located distally on the first ring member relative to the first recessed region, and the interlocking formation of the second ring member includes a vaulted region and a second projection, the second projection extending generally downwardly relative to the vaulted region at a position located distally on the second ring member relative to the vaulted region, wherein the first projection is received in the vaulted region and the second projection is received in the recessed region when the interlocking formations are in the retaining position, and wherein the interlocking formations are configured so that movement of the interlocking formations relative to one another in the direction of the longitudinal axis of the body is blocked when the interlocking formations are in the retaining position.

2. A ring binder as set forth in claim 1 wherein movement of the interlocking formations from the retaining position to the non-retaining position requires vertical movement of the interlocking formation of the first ring member relative to the interlocking formation of the second ring member.

3. A ring binder as set forth in claim 1 wherein the recessed region does not extend all the way vertically through the first ring member and the vaulted region does not extend all the way vertically through the second ring member.

4. A ring binder as set forth in claim 1 wherein the recessed region extends all the way laterally through the first ring member and the vaulted region extends all the way laterally through the second ring member.

5. A ring binder as set forth in claim 4 wherein the first and second ring members each have an elliptical cross sectional shape.

6. A ring binder as set forth in claim 5 wherein first and second projections are in abutting relation to one another when the interlocking formations are in the retaining position and gaps associated with the abutting projections appear only on opposite sides of the rings, the gaps being located at narrow ends of the elliptical cross sectional shape of the ring members.

7. A ring binder as set forth in claim 6 wherein a joint formed by the abutment of the first and second projections is recessed within the gaps.

8. A ring binder as set forth in claim 7 wherein the first and second projections have rounded surfaces extending from the joint to the edges of the gaps.

9. A ring binder as set forth in claim 1 wherein the recessed region is defined by a bottom and a pair of sidewalls on opposite sides of the bottom.

10. A ring binder as set forth in claim 9 wherein at least one of the sidewalls is not straight.

11. A ring binder as set forth in claim 10 wherein neither of the sidewalls is straight.

12. A ring binder as set forth in claim 11 wherein the second projection has a convex curved surface configured to abut one of the sidewalls when the interlocking formations are in their retaining position and a concave curved surface configured to abut the other of the sidewalls when the interlocking formations are in their retaining position.

13. A ring binder as set forth in claim 12 wherein the recessed region has an arcuate shape.

14. A ring binder as set forth in claim 13 wherein the vaulted region is defined by a top and a pair of sidewalls on opposite sides of the top.

15. A ring binder as set forth in claim 14 wherein at least one of the sidewalls forming the vaulted region is not straight.

16. A ring binder as set forth in claim 15 wherein the first projection has a pair of convex curved surfaces on opposite sides of the projection, and one of the convex surfaces of the first projection is configured to abut one of the sidewalls of the vaulted region when the interlocking formations are in their retaining position, and the other of the convex curved surfaces is configured to abut the other of the sidewalls of the vaulted region when the interlocking formations are in their retaining position.

17. A ring binder as set forth in claim 1 wherein the vaulted region is defined by a top and a pair of sidewalls on opposite sides of the top.

18. A ring binder as set forth in claim 17 wherein at least one of the sidewalls forming the vaulted region is not straight.

19. A ring binder as set forth in claim 18 wherein the first projection has a pair of convex curved surfaces on opposite sides of the projection, and one of the convex surfaces of the first projection is configured to abut one of the sidewalls of the vaulted region when the interlocking formations are in their retaining position, and the other of the convex curved surfaces is configured to abut the other of the sidewalls of the vaulted region when the interlocking formations are in their retaining position.

20. A ring binder as set forth in claim 1 wherein an upper surface of said at least one ring has only a single joint where the interlocking formations meet one another, a lower surface of said at least one ring has only a single joint where the interlocking formations meet one another, and a side of said at least one ring has more than one joint where the interlocking formations meet one another, and wherein the ring members of said at least one ring each have an elliptical cross sectional shape, the side of the ring being positioned at a narrow end of said elliptical cross sectional shape.
